(19) United States
(12) Patent Application Publication
(10) Pub. No.: US 2013/0339269 A1
(43) Pub. Date: Dec. 19, 2013

(54) COMPUTER-IMPLEMENTED SYSTEM AND METHOD FOR CREATING OPPORTUNITIES TO INCREASE BUSINESS CONNECTIONS

(71) Applicants: Russell Castro, Marlboro, NJ (US); Andrea Castro, Marlboro, NJ (US)

(72) Inventors: Russell Castro, Marlboro, NJ (US); Andrea Castro, Marlboro, NJ (US)

(21) Appl. No.: 13/864,174

(22) Filed: Apr. 16, 2013

Related U.S. Application Data
(60) Provisional application No. 61/624,530, filed on Apr. 16, 2012.

(51) Int. Cl. G06Q 30/02

(52) U.S. Cl. CPC G06Q 30/0201
USPC 705/345

(57) ABSTRACT

Embodiments of the present invention are generally related to a computer-implemented system and method for creating opportunities to increase business connections. In one embodiment, a method for creating opportunities to increase business connections comprises: enabling a first user to upload business data via a network to the administrator, and create a first user account; issuing the first user a first unique identifier for placement on a tangible article; enabling a second user to access the computer system via the network, upload data affiliated with the first unique identifier of the first user, and view the uploaded business data of the first user; and facilitating the development of a professional relationship between the first user and second user by enabling both the first and second user access a communication means via the network.

### CROSS-REFERENCE TO RELATED APPLICATIONS

This application claims priority to U.S. Provisional Patent Application Ser. No. 61/624,530, filed Apr. 16, 2012, entitled “Computer-Implemented System and Method for Creating Opportunities to Increase Business Connections,” the disclosure of which is incorporated herein by reference in its entirety.

### BACKGROUND

1. Field of the Invention

Embodiments of the present invention are generally related to a computer-implemented system and method for creating opportunities to increase business connections. More specifically, embodiments of the present invention relate to a system and method of creating opportunities to increase business connections through the utilization of a tangible article having a unique identifier thereon.

2. Description of Related Art

Every day, business owners may miss opportunities to pick up a new client because those potential clients do not notice the business owner, or would have a clue what that person does for a living absent a conversation. Even at a networking event or social gathering with hundreds of people, it is very difficult for a business owner to introduce him or herself to everyone. In short, there are likely too many unknown scenarios where an ideal prospective client may be standing ten feet away, but because it may be considered socially awkward to randomly ask strangers what they do for a living, the connection is never made.

Thus, there is a need for a computer-implemented system and method for creating opportunities to increase business connections.

### SUMMARY

Embodiments of the present invention are generally related to a computer-implemented system and method for creating opportunities to increase business connections. More specifically, embodiments of the present invention relate to a system and method of creating opportunities to increase business connections through the utilization of a tangible article having a unique identifier thereon.

In one embodiment of the present invention, a method for creating opportunities to increase business connections utilizing a computer system hosted at an administrator, the computer system having a processor, wherein the processor executes steps of the method, the method comprises: enabling a first user to upload business data via a network to the administrator, and create a first user account; issuing the first user a first unique identifier for placement on a tangible article; enabling a second user to access the computer system via the network, upload data affiliated with the first unique identifier of the first user, and view the uploaded business data of the first user; and facilitating the development of a professional relationship between the first user and second user by enabling both the first and second user access a communication means via the network.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system-level network diagram of a system for creating opportunities to increase business connections in accordance with one embodiment of the present invention;

FIG. 2 depicts a block diagram of a general computer system, which is capable of being used in connection with the system depicted in FIG. 1, in accordance with another embodiment of the present invention;

FIG. 3 depicts a flow diagram illustrating a method for creating opportunities to increase business connections in accordance with one embodiment of the present invention; and

FIG. 4 depicts exemplary tangible articles having a unique identifier thereon, in accordance with one exemplary embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a computer-implemented system and method for creating opportunities to increase business connections. More specifically, embodiments of the present invention relate to a system and method of creating opportunities to increase business connections through the utilization of a tangible article having a unique identifier thereon.

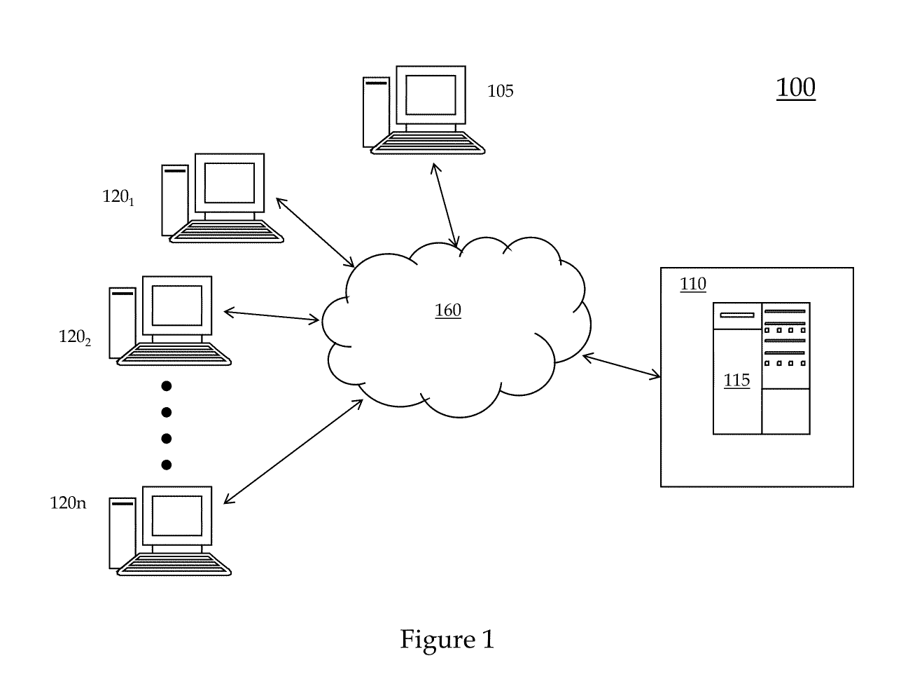

FIG. 1 depicts a system-level network diagram of a system for creating opportunities to increase business connections in accordance with one embodiment of the present invention. The system 100 generally comprises at least a first user 105 and secondary users 120₁ and 120₂, each in communication with an administrator 110, generally hosting a central server 115, through a network 150. Methods in accordance with one or more embodiments of the present invention take place over the network 150, which may comprise a global computer network, for example, the Internet.

Although FIG. 1 explicitly depicts three secondary users (labeled “User 2” 120₁, “User 3” 120₂, and “User N” 120_{N}), it should be appreciated that N represents any number of users feasible in accordance with embodiments of the present invention. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present invention. That is, in certain embodiments, multiple users may perform the same or similar functions as the first user 105. As understood by embodiments of the present invention, a user may include any person, business or entity, capable of participating in the system and methods disclosed herein.

The first user 105 generally provides a service or sells goods of a particular nature and may be in the market to increase business connections in relation thereto. For example, the first user 105 may provide a home-related service (e.g., plumber, contractor, painter, etc.), a professional service (e.g., doctor, lawyer, etc.), a personal service (e.g., masseuse, hairdresser, etc.), a business-related service (e.g., web developer, marketing director, printer, etc.), or the like. Alternatively, the first user 105 may sell goods, such as knife sets, plastic containers, make-up/skin creams, electronics, office supplies, furniture, or the like.

The secondary users 120 may generally be persons or entities having an interest in the goods and/or services being provided by the first user 105. The interest may be a consumer interest (e.g., the secondary user 120 may wish to acquire the goods or services of the first user 105), or a professional interest (e.g., the secondary user 120 may wish to partner with, work for, etc., the first user 105). In alternative embodiments, the interest may be an inquisitive interest, whereby the secondary user 120 merely seeks to discuss the goods or services with the first user 105.

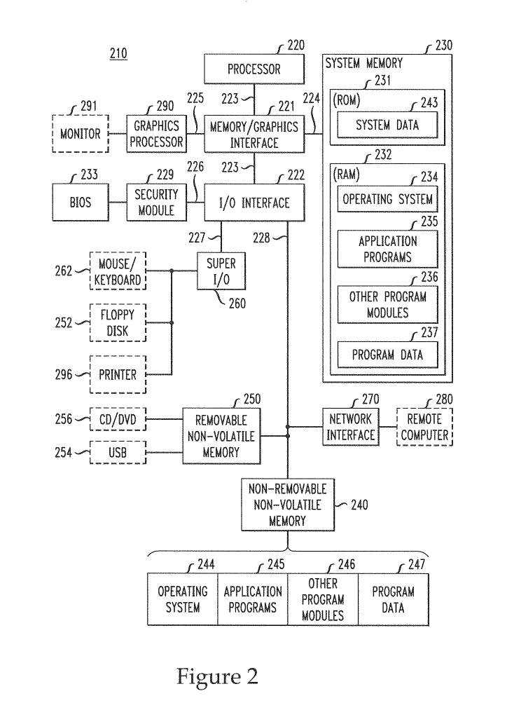

In a basic exemplary embodiment, within the system 100, the first user 105, and/or any of the secondary users 120, may be capable of transmitting data to and from an administrator 110 using a communication device. A communication device in the context of embodiments of the present invention may include, but is not limited to, a personal computer, a portable computer, a handheld computer, a cellular phone, a smart phone, a digital tablet, a laptop computer, a netbook, an Internet appliance, an Apple iPhone, a Blackberry device, a Personal Data Assistant (PDA) or the like, or may generally include a general purpose computer, as discussed below with respect to FIG. 2.

The administrator 110 generally comprises a server 115, which may further host an accessible data portal (e.g., a website, a social network, or the like). The accessible data portal, which may be accessible to the first user 105 and any of the secondary users 120, communicates with each user through the network 160. The accessible data portal may comprise any number of security measures to provide a reasonably secure system, suitable for embodiments of the present invention. The accessible data portal may further comprise a graphical user interface (GUI) through which any of the first user 105 or secondary users 120 may access the server 115.

The server 115 may also comprise a database or other sortable data storage memory to enable the system and methods disclosed herein. In many embodiments, the database may be any commercially available data storage database suitable for embodiments of the present invention. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first user 105, wherein a plurality of user-specific data is stored. The database may also include any number of subsequent data sets representing N users, wherein N represents any number of users practical for operation of embodiments of the present invention.

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

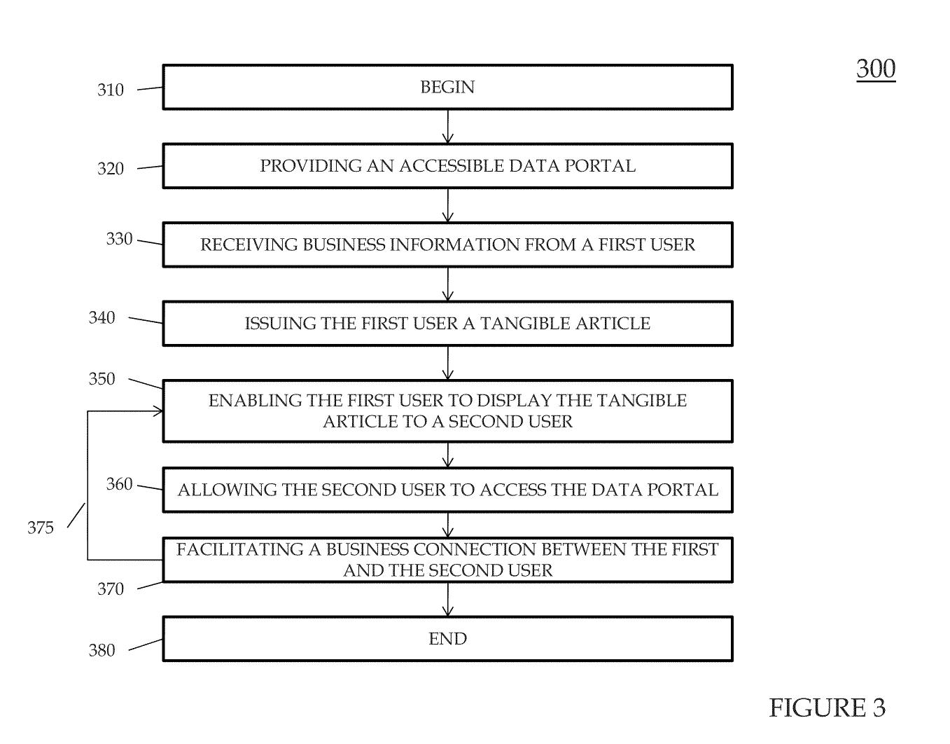

FIG. 3 depicts a flow diagram illustrating a method for creating opportunities to increase business connections in accordance with one embodiment of the present invention. The method 300 may be carried out using the architecture and components described in the systems above, or may utilize any other type of system architecture suitable for embodiments of the present invention. It should further be appreciated, the steps of method 300 may be carried out in any order (e.g., step 340 may occur before step 330), unless otherwise explicitly specified by the steps of the exemplary method.

The method 300 begins at step 310. At step 320, an accessible data portal (e.g., interactive website) is provided. The accessible data portal communicates with any number of users through a network, for example a global computer network, such as the Internet. The accessible data portal may comprise any number of security measures to provide a reasonably secure system, suitable for embodiments of the present invention. The accessible data portal may further comprise a graphical user interface (GUI) through which any of the users may access the server or database hosted therein.

At step 330, business information is received from a first user. In many embodiments, the business information is used for administrative purposes only, and may not be distributed or accessible to any other members of the system. Such business information may include, for example, a name, mailing address, email address, telephone number and/or the like. The business information may additionally comprise a description of the goods and/or services provided by the first user. In many embodiments, exemplary services and/or goods may be described and/or shown via multimedia data uploaded by the first user.

In further embodiments, the first user may provide a username and desired password. Alternatively, the username and password may automatically be assigned by the system, through a random generator or the like. The amount of information provided by the first user may vary depending on the needs of the administrator, and in some embodiments, may only require the providing of a username and password.

In many embodiments, the first user provides the business information to the system administrator by utilizing a communication device, as described hereinabove. Alternatively, however, the first user may fill out a paper form, place a telephone call to a system operator, or the like, to provide such information to the system administrator.

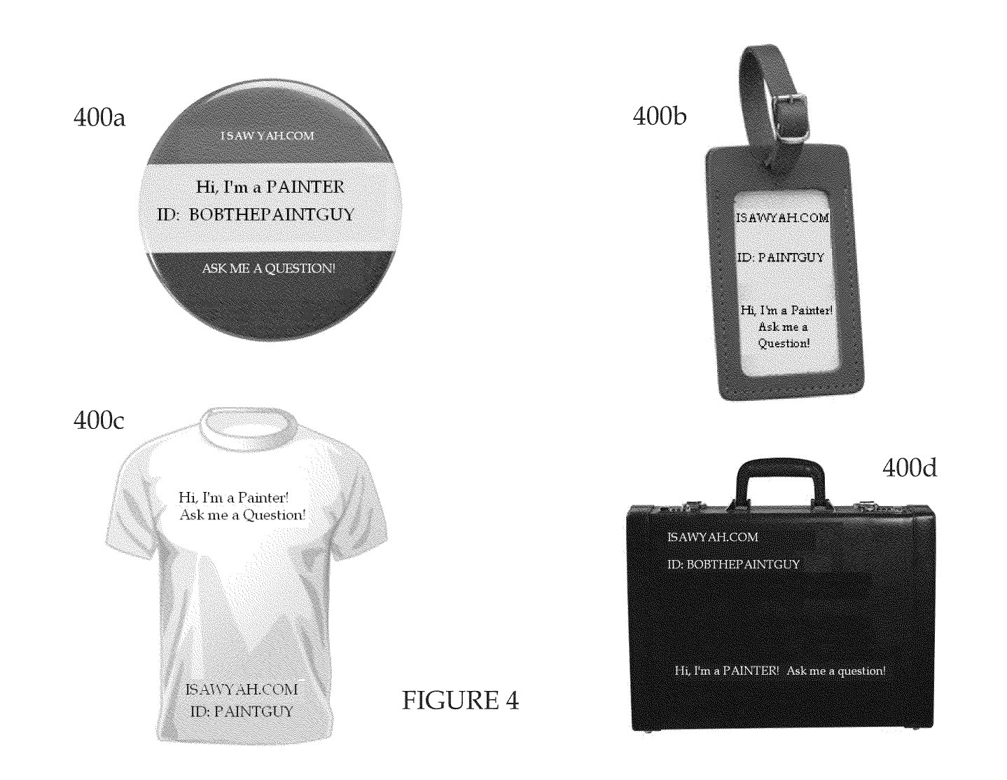

At step 340, the first user is issued at least one tangible article. Exemplary tangible articles are shown in FIG. 4.

As shown in the Figure, tangible articles may take the form of any type of tangible item suitable for embodiments of the present invention. In one embodiment, the tangible article comprises a button 400a, for wearing on a first user's shirt, jacket, dress, or the like. In another embodiment, the tangible article comprises a tag 400b, such as a hang tag or luggage tag, for attaching to a user's bag or similar apparatus. In a further embodiment, the tangible article comprises an article of clothing, such as a t-shirt 400c. In yet a further embodiment, the tangible article comprises a bag, purse, briefcase 400d, or the like.

In many of such embodiments, the tangible article comprises written information thereon. For example, the tangible article 400 may comprise any eye-grabbing material and/or a phrase, slogan or tag line. In one embodiment, the tangible article 400 may comprise advertising for the administrator of the system, as shown as the eye-grabbing material. As understood by embodiments of the present invention, any form of eye-grabbing printed material, including a plain/blank color surface, may suffice.

In many embodiments, the tangible article 400 comprises a unique identifier thereon. In one embodiment, a unique identifier comprises a coded identity of the first user. For example, in some embodiments, the unique identifier comprises the username of the first user, as described above. In other embodiments, the unique identifier comprises an c coded form of the username of the first user, in the form of a barcode, quick read (QR) code, RFID code, or the like. In yet further embodiments, the unique identifier comprises an arbitrary code, issued solely to the first user. Generally, the unique identifier is the same for all the tangible articles issued to the first user.

In other embodiments, the tangible article 400 may further comprise instructions for contacting the first user through the system. For example, in one embodiment, on the tangible article 400, a phrase such as: “Connect with me at: isawyah.com” may be provided. Any other form of instruction may be suitable for embodiments of the present invention as well.

In many embodiments, the tangible article 400 has a printed layout, such that a front side of the tangible article 400 comprises the printed logo or trademark 414 of the administrator. In such embodiments, the tangible article 400 may comprise a set of instructions, and a unique identifier. In certain embodiments, the logo of the administrator may also be printed on another side of the tangible article 400 as well. In certain embodiments, the tangible article 400 may also include advertisements for third parties (not shown). It should be appreciated, however, embodiments of the present invention encompass printing of the requisite information anywhere on the tangible article 400, regardless of side or positioning.

Although described in tangible form, in addition to the description above, the tangible article of the present invention may be in the form of a label, sticker, patch, magnets, etc., whereby the tangible article may have information printed thereon. In an exemplary embodiment, the first user may be able to affix such labels to any ordinary article chosen by the first user. In such embodiments, the label or sticker may generally be a polymer-based label or sticker and may generally be removable, e.g., due to the nature of the materials, a removable adhesive, or the like.

Returning to FIG. 3, at step 350, the first user may display the tangible articles to a secondary user. As discussed hereinabove, even a brief physical encounter between two persons (e.g., a brief discussion in an elevator, a ride on a bus, etc.) may be sufficient to expose the secondary user to enough information about the first user, such that it may invoke questions, comments, inquiries, etc., by the secondary user about the first user. In accordance with one embodiment of the present invention, rather than worrying about discussing information or questions in the public setting, or awkwardly exchanging phone numbers, email addresses or the like, during such a brief encounter, the second user may make note of the unique identifier on the tangible article.

At step 360, the second user, if interested in the business of the first user, may access the data portal of the system. In many embodiments, the second user may access the data portal using a communication device through the network. When the second user reaches the data portal, an access screen may require the entry of at least the unique identifier on the tangible article seen by the second user. In certain embodiments, the second user may also be able to provide personal information during this step. The personal information may be similar to the business information provided by the first user above, and in many instances, may only require the submission of a username and/or password.

At step 370, the administrator may facilitate the development of a professional relationship between the first and second user by allowing both the first and second user access any number of means of communication or communication tools within the system. For example, in one embodiment, the first and second user may communicate utilizing an internal mail/message tool, an instant message tool, or the like. In some embodiments, advanced features, such as video messaging or network-assistant voice communication (e.g., Voice over IP technology) may also be available to the users of the system.

Embodiments of the present invention may be fully engaged with the well-known tools a social network. As such, if a business connection extends beyond initial correspondence, as explained in step 370, the first and second user may continue to communicate through sharing of data, including photos, videos, etc., until such relationship is ready to extend beyond the virtual world and back into the real world.

At step 375, the method 300 may revert back to step 350 by allowing the first user to continue to display the tangible article to additional secondary users. The method 300 ends at step 380.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. A method for creating opportunities to increase business connections utilizing a computer system hosted at an administrator, the computer system having a processor, wherein the processor executes steps of the method, the method comprising:
enabling a first user to upload business data via a network to the administrator, and create a first user account;
issuing the first user a first unique identifier for placement on a tangible article;
enabling a second user to access the computer system via the network, upload data affiliated with the first unique identifier of the first user, and view the uploaded business data of the first user; and
facilitating the development of a professional relationship between the first user and second user by enabling both the first and second user access a communication means via the network.
